(19) United States
(12) Patent Application Publication
(10) Pub. No.: US 2011/0064894 A1
(43) Pub. Date: Mar. 17, 2011

(54) INKJET RECORDING MEDIUM

(75) Inventor: Hideki KAIMOTO, Shizuoka-ken (JP)

(73) Assignee: FUJIFILM CORPORATION, Tokyo (JP)

(21) Appl. No.: 12/881,219

(22) Filed: Sep. 14, 2010

(30) Foreign Application Priority Data
Sep. 17, 2009 (JP) 2009-216113

(51) Int. Cl. B41M 5/52

(52) U.S. Cl. 428/32.34

(57) ABSTRACT

The invention provides an inkjet recording medium having at least a non-water-absorptive support, an undercoat layer provided on the non-water-absorptive support, and an ink-receiving layer provided on the undercoat layer, the undercoat layer containing at least: a first water-soluble resin selected from the group consisting of: a water-soluble polyamide resin that is other than an α-amino acid derived polyamide resin; a derivative of a water-soluble polyamide resin that is other than a derivative of an α-amino acid derived polyamide resin; and a water-soluble polyvinyl acetal, the ink-receiving layer containing at least first inorganic fine particles and a second water-soluble resin, and in the case that the undercoat layer contains second inorganic fine particles, a mass ratio of a content of the second inorganic fine particles in the undercoat layer to a content of the first water-soluble resin in the undercoat layer being 0.1 or less.

### CROSS-REFERENCE TO RELATED APPLICATION

This application claims priority under 35 USC 119 from Japanese Patent Application No. 2009-216113 filed on Sep. 17, 2009, the disclosure of which is incorporated by reference herein.

### BACKGROUND

1. Field of the Invention

The present invention relates to an inkjet recording medium.

2. Related Art

In recent years, along with rapid development in the information industry, a variety of information processing systems have been developed, and recording methods and recording devices suitable for the respective information processing systems have also been developed and put to practical use. Among these recording methods, an inkjet recording method has been widely used not only in offices but also in private homes, because the inkjet recording method has the advantages that the method allows recording on a variety of recording media, hardware (apparatus) is relatively inexpensive and compact, the method is excellent in terms of quietness, and the like.

Further, along with the recent trend in inkjet printers toward higher definition and the recent development of hardware (apparatus), various kinds of media for use in inkjet recording (hereinafter, also referred to as “inkjet recording media”) are being developed and, more recently, it has become possible to obtain photograph-like high-quality recorded materials.

Specifically, an inkjet recording medium is generally required to have properties such as (1) quick-drying properties (high ink absorption rate), (2) appropriate and uniform ink dot diameter (without ink blur), (3) excellent granularity, (4) high dot circularity, (5) high color density, (6) high saturation (without dullness), (7) excellent light fastness, gas resistance, and water resistance of a printed image portion, (8) a high degree of whiteness of a recording face, (9) excellent storability of a recording medium (absence of yellowing and image blurring during long-term storage), (10) resistance to deformation and excellent dimensional stability (sufficiently low curling), and (11) excellent traveling properties within hardware.

Further, with regard to photographic glossy paper which is used for obtaining photograph-like high-quality recorded materials, properties such as glossiness, surface smoothness, texture similar to that of silver salt photographic paper, and the like are also required in addition to these properties.

Examples of an inkjet recording medium which may satisfy the requirements include an inkjet recording medium having a primer layer containing resins such as an ethylene-vinyl acetate copolymer or polyvinyl acetal and a porous ink-receiving layer provided on a void-containing polyolefine film in this order (for example, see Japanese Patent Application Laid-Open (JP-A) No. 2003-182208).

Examples thereof further include an inkjet recording sheet having a porous colorant-receiving layer provided on a support, the support being a resin-coat paper having resin layers provided on both surfaces thereof and the resin layer provided on the colorant-receiving layer side contains a silver-white type pearly gloss pigment (for example, see JP-A No. 2004-276418).

### SUMMARY

The resin contained in the primer layer described in JP-A No. 2003-182208 is a hydrophobic resin, which may have little effect to improve color density of image formed of a dye ink. The inkjet recording sheet described in JP-A No. 2004-276418 may have insufficient scratch resistance. In short, the inkjet recording media of JP-A Nos. 2003-182208 and 2004-276418 may not be satisfactory in terms of color density and brittleness resistance.

The present invention was made in consideration of the above circumstances.

One exemplary embodiment of the present invention is an inkjet recording medium comprising a non-water-absorptive support, an undercoat layer provided on the non-water-absorptive support, and an ink-receiving layer provided on the undercoat layer, the undercoat layer comprising a first water-soluble resin selected from the group consisting of: a water-soluble polyamide resin that is other than an α-amino acid derived polyamide resin; a derivative of a water-soluble polyamide resin that is other than a derivative of an α-amino acid derived polyamide resin; and a water-soluble polyvinyl acetal, the ink-receiving layer comprising first inorganic fine particles and a second water-soluble resin, and in the case that the undercoat layer comprises second inorganic fine particles, a mass ratio of a content of the second inorganic fine particles in the undercoat layer to a content of the first water-soluble resin in the undercoat layer being 0.1 or less.

### DETAILED DESCRIPTION

### Inkjet Recording Medium

The inkjet recording medium herein provided has at least a non-water-absorptive support, an undercoat layer provided on the non-water-absorptive support, and an ink-receiving layer provided on the undercoat layer. The undercoat layer contains at least: a first water-soluble resin selected from the group consisting of: a water-soluble polyamide resin that is other than an α-amino acid derived polyamide resin; a derivative of a water-soluble polyamide resin that is other than a derivative of an α-amino acid derived polyamide resin; and a water-soluble polyvinyl acetal The ink-receiving layer contains at least first inorganic fine particles and a second water-soluble resin. In the case that the undercoat layer contains second inorganic fine particles, a mass ratio of a content of the second inorganic fine particles in the undercoat layer to a content of the first water-soluble resin in the undercoat layer is 0.1 or less.

It is remarked that the undercoat layer may either contain or not contain inorganic fine particles.

This configuration of the inkjet recording medium may facilitate to make the inkjet recording medium to have high color density and high brittleness resistance.

Conventionally, when an undercoat layer is provided between a support and an ink-receiving layer, the undercoat layer is generally one that contains gelatin as a main ingredient thereof, in view of improving ink applicability or adhesion upon coating. In contrast to this, in the inkjet recording medium according to the present embodiment, the first water-soluble resin, that is a polymer having higher water-solubility and flexibility than gelatin, is contained in the undercoat layer. The inclusion of the first water-soluble resin may facilitate to decentralize a stress applied to the inkjet recording medium and thus, the inkjet recording medium may be hardly damaged and the brittleness resistance thereof may be enhanced. Further, the first water-soluble resin contained in the undercoat layer may absorb ink solvent more easily than gelatin, so that the color density may be improved.

Details of the undercoat layer, the ink-receiving layer, and the non-water-absorptive support are described below.

Undercoat Layer

The inkjet recording medium has an undercoat layer that contains at least one kind of the first water-soluble resin selected from the group consisting of a water-soluble polyamide resin or a derivative thereof and a water-soluble polyvinyl acetal, in which the water-soluble polyamide resin is not an α-amino acid derived polyamide resin.

In embodiments, the undercoat layer may further contain, besides the first water-soluble resin, other components such as inorganic fine particles as long as the effect of the inkjet recording medium is not impaired.

First Water-Soluble Resin

The first water-soluble resin is selected from the group consisting of: a water-soluble polyamide resin that is other than an α-amino acid derived polyamide resin; a derivative of a water-soluble polyamide resin that is other than a derivative of an α-amino acid derived polyamide resin; and a water-soluble polyvinyl acetal.

Water-Soluble Polyamide Resin or Derivative Thereof

There is no particular limitation to the “water-soluble polyamide resin that is other than an α-amino acid derived polyamide resin” as long as it is a water-soluble resin having an amide bonding (—NHCO—) except an α-amino acid derived polyamide resin, and there is no particular limitation to the “derivative of a water-soluble polyamide resin that is other than a derivative of an α-amino acid derived polyamide resin” as long as it is a derivative of a water-soluble resin having an amide bonding (—NHCO—) except a derivative of an α-amino acid derived polyamide resin.

The α-amino acid derived polyamide resin and a derivative thereof (for example, gelatin and protein) is not included in the scope of the first water-soluble resin.

Hereinafter, “water-soluble polyamide resin” denotes a water-soluble polyamide resin except an α-amino acid derived polyamide resin. Further, “water-soluble polyamide resin or a derivative thereof” denotes the water-soluble polyamide resin or a derivative of the water-soluble polyamide resin, and has the same scope as “a water-soluble polyamide resin that is other than an α-amino acid derived polyamide resin or a derivative of a water-soluble polyamide resin that is other than a derivative of an α-amino acid derived polyamide resin”.

Examples of the water-soluble amino resin include a compound (copolymer) that is formed by copolymerizing polyamide resin and a hydrophilic compound.

The derivative of the water-soluble polyamide resin is referred to as a compound having an amide bonding structure that is altered by substitution of the atom involved in the water-soluble polyamide resin molecule or by addition reaction. Examples thereof include a compound in which a methoxymethyl group (CH₂OCH₃) substitutes for the hydrogen atom of amide bonding (—CONH—).

Examples of the polyamide resin include a so-called “n-nylon” that is synthesized through ω-amino acid polymerization and a so-called “n, m-nylon” that is synthesized through copolymerization of diamine and dicarboxylic acid. In embodiments, among these, a copolymer from diamine and dicarboxylic acid may be preferable, and a reaction product from ε-caprolactam and dicarboxylic acid may be more preferable, from the viewpoint of imparting hydrophilicity.

Examples of the hydrophilic compound include a hydrophilic nitrogen-containing cyclic compound and a polyalkylene glycol.

The “hydrophilic nitrogen-containing cyclic compound” herein means a compound that has a tert-amine moiety on the side or main chain thereof, and examples thereof include aminoethyl piperazine, bisaminopropyl piperazine, and α-dimethylamino ε-caprolactam.

The polyalkylene glycol is represented by R¹O—(CH₂CH(R²)O)—R³, for example. Here, R¹ to R³ each independently represents a hydrogen atom or an alkyl group having 1 to 3 carbon atoms. In embodiments, among these, it may be preferably one in which R¹ and R³ respectively represent a hydrogen atom, and R² represents an alkyl group having 1 to 2 carbon atoms.

The compound that is formed by copolymerizing polyamide resin and a hydrophilic compound is superior to conventionally used N-methoxymethylated nylon in terms of the adhesion between the non-water-absorptive support and the ink-receiving layer, considering the following points.

Conventional N-methoxymethylated nylon is obtained by introducing a methoxymethyl group into the amide bonding portion, which is included in the main chain of the nylon and easily forms an intermolecular hydrogen bonding. The amide bonding in the nylon main chain may thus lose its hydrogen bonding capability, and that the crystallinity of the nylon may be limited and the nylon may dissolve into alcohol.

On the other hand, the compound that formed by copolymerizing polyamide resin and a hydrophilic compound has such a structure that at least one compound that is selected from the group consisting of a hydrophilic nitrogen-containing cyclic compound and a polyalkylene glycol is copolymerized in the main chain of the polyamide resin, so that the amide bonding of the polyamide resin may have a larger capability of forming hydrogen bonding as compared with the N-methoxymethylated nylon.

In embodiments, among the compounds that are formed by copolymerizing polyamide resin and a hydrophilic compound, (1) a reaction product formed from ε-caprolactam, a hydrophilic nitrogen-containing cyclic compound and dicarboxylic acid, and (2) a reaction product formed from ε-caprolactam, a polyalkylene glycol and dicarboxylic acid may be preferable. These are commercially available as, for example “AQ-NYLON” (trade name, manufactured by Toray Industries Inc.). The reaction product from ε-caprolactam, a hydrophilic nitrogen-containing cyclic compound and dicarboxylic acid is available as “AQ-NYLON A-90” (trade name, manufactured by Toray Industries Inc.). The reaction product from ε-caprolactam, a polyalkylene glycol and dicarboxylic acid is available as “AQ-NYLON P-70” (trade name, manufactured by Toray Industries Inc.).

Water-Soluble Polyvinyl Acetal

There is no particular limitation to the water-soluble polyvinyl acetal resin. Examples thereof include a polymer that is formed by using, as a component thereof, polyvinylalcohol or a compound such as vinyl acetate that is obtained by partly or totally esterifying polyvinyl alcohol.

The water-soluble polyvinyl acetal resin that is formed by using polyvinyl alcohol as a component thereof may be obtained, for example, by acetalization of polyvinyl alcohol with aldehyde. The water-soluble polyvinyl acetal resin that is formed by using, as a component thereof, the compound obtained by partly or totally esterifying polyvinyl alcohol may be obtained, for example, by carrying out saponification and acetalization in parallel using, as a start source material, the compound obtained by partly or totally esterifying polyvinyl alcohol. Examples of a method for the acetalization include conventionally known processes such as the dissolution process, the precipitation process, and the homogeneous process.

The polyvinyl alcohol that is used as a source material for the water-soluble polyvinyl acetal resin is not particularly limited. In embodiments, the polyvinyl alcohol may generally have a polymerization degree of from 300 to 4,500 and preferably from 500 to 4,500. A higher polymerization degree may be desirable for higher water-resistance.

The saponification degree of the polyvinyl alcohol portion is not also particularly limited. In embodiments, the saponification degree may be generally from 80.0 mol % to 99.5 mol %. From the viewpoint of obtaining a higher water-resistance, a lower saponification degree may be desirable as long as the water-solubility thereof is kept.

Examples of the aldehyde that is used as a source material for the water-soluble polyvinyl acetal resin include: an aliphatic aldehyde such as formaldehyde, acetaldehyde, butylaldehyde, hexylaldehyde, octylaldehyde, or decylaldehyde; an aromatic aldehyde such as benzaldehyde, 2-methylbenzaldehyde, 3-methylbenzaldehyde, 4-methylbenzaldehyde, other alkyl-substituted benzaldehydes, chlorobenzaldehyde, other halogen-substituted benzaldehydes, phenylacetaldehyde, β-phenylpropione aldehyde, or other phenyl-substituted alkylaldehydes; and an aromatic aldehyde having, in the aromatic ring thereof, a substituted group such as a hydroxy group, an alkoxy group, an amino group, or a cyano group. Examples of the aldehyde further include an aldehyde having a condensed aromatic ring such as naphthaldehyde or anthraldehyde. Among these, from the viewpoint of obtaining a resin that keeps the water solubility and is adequate in both water-resistance and transparency, butylaldehyde, acetaldehyde, and hexylaldehyde may be preferable.

The acetalization degree of the water-soluble polyvinyl acetal resin may be generally in the range of from 2 mol % to 40 mol %, preferably from 3 mol % to 35 mol %, and more preferably from 15 mol % to 35 mol %. When the acetalization degree is 2 mol % or more, lowering in brittleness-resistance may be suppressed, and when the acetalization degree is 40 mol % or less, lowering in color density may be suppressed.

Commercially available products may be used as the water-soluble polyvinyl acetal, and examples thereof include “S-LEK” (trade name, manufactured by SEKISUI CHEMICAL CO., LTD.).

Other Water-Soluble Resins

In embodiments, the undercoat layer may further contain a water-soluble resin other than the first water-soluble resin as long as the effect that is obtainable by the inkjet recording medium is not impaired. Examples of the water-soluble resin other than the first water-soluble resin include a water-soluble polyamide resin or a derivative thereof and a water-soluble resin except the water-soluble polyvinyl acetal. Specific examples thereof include polyvinyl alcohol (PVA) and cellulose. From the viewpoint of suppressing impairing of the effect obtained by the inkjet recording medium, a water-soluble resin that is an α-amino acid derived polyamide resin and a derivative thereof, which is typically gelatin, is eliminated from the range of the water-soluble resin that can be contained in the undercoat layer.

Second Inorganic Fine Particles in Undercoat Layer

In embodiments, the undercoat layer may further contain inorganic fine particles, which are herein referred to as second inorganic fine particles.

Examples of the second inorganic fine particles include silica fine particles, colloidal silica, alumina fine particles, titanium dioxide, barium sulfate, calcium silicate, zeolite, kaolinite, halloysite, mica, talc, calcium carbonate, magnesium carbonate, calcium sulfate, pseudo-boehmite, zinc oxide, zinc hydroxide, alumina, aluminum silicate, calcium silicate, magnesium silicate, zirconium oxide, zirconium hydroxide, cerium oxide, lanthanum oxide and yttrium oxide. Of these, silica fine particles, colloidal silica, alumina fine particles and pseudo-boehmite may be preferable from the viewpoint of forming an excellent porous structure. The second inorganic fine particles may be used in the form of primary or secondary particles. The second inorganic fine particles may be inorganic fine particles of a single kind or may be a mixture of plural kinds of inorganic fine particles. In embodiments, silica fine particles with an average primary particle diameter of 20 nm or less, colloidal silica with an average primary particle diameter of 30 nm or less, alumina fine particles with an average primary particle diameter of 20 nm or less, and pseudo-boehmite with an average pore radius of 2 nm to 15 nm may be preferable, and such silica fine particles, such alumina fine particles and such pseudo-boehmite may be more preferable.

The kind of water-soluble resins employed herein may be selected in consideration that the combination of inorganic fine particles (specifically silica fine particles) and the water-soluble resins may affect the color density and the brittleness resistance of the inkjet recording medium.

Content Ratio of Second Inorganic Fine Particles to First Water-Soluble Resin

In the undercoat layer, the mass ratio of the content of the second inorganic fine particles to the content of the first water-soluble resin (inorganic fine particles/first water-soluble resin in the undercoat layer) is 0.1 or less. In the case in which the mass ratio falls within this range (namely, in the case in which the content of the first water-soluble resin is larger than that of the second inorganic fine particles to attain this content ratio), the water absorption property and flexibility that are possessed by the first water-soluble resin may emerge, and the color density and brittleness-resistance of the inkjet recording medium may be developed.

Hereinafter, the mass ratio of the content of inorganic fine particles (P) to the content of the water-soluble resin (B) [inorganic fine particles (P)/water-soluble resin (B)] may be abbreviated as “PB ratio” in some cases. In the undercoat layer, the PB ratio denotes the mass ratio of the content of the second inorganic fine particles to the content of the first water-soluble resin (second inorganic fine particles/first water-soluble resin in the undercoat layer). In the ink-receiving layer that is described below, the PB ratio denotes the mass ratio of the content of the first inorganic fine particles to the content of a second water-soluble resin (first inorganic fine particles/second water-soluble resin in the ink-receiving layer).

In the undercoat layer, the PB ratio may be preferably less than 0.05, considering the brittleness-resistance of the inkjet recording medium, and may be more preferably 0 (zero) (that is, the undercoat layer may contain substantially no inorganic fine particles).

Other Components of Undercoat Layer

In embodiments, the undercoat layer may further contain, besides the first water-soluble resin and the inorganic fine particles, a surfactant and the like as needed.

Amount of Undercoat Layer Applied on Support

The undercoat layer may be formed by applying (by coating, for example), on a non-water-absorptive support, an undercoat layer forming liquid that contains the components such as the first water-soluble resin. The undercoat layer forming liquid may be prepared in the form of a mixture liquid by adding, to water, the first water-soluble resin, and the inorganic fine particles and/or a surfactant as needed, and mixing.

The content of the first water-soluble resin in the undercoat layer may be preferably in the range of from 0.02 g/m² to 5 g/m², and more preferably from 0.05 g/m² to 1 g/m², in terms of a solid content by mass. When the application amount is 0.02 g/m² or more, deterioration in brittleness-resistance and color density may be suppressed. When the coating amount is 5 g/m² or less, deterioration in water-resistance may be suppressed.

Ink-Receiving Layer

The ink-receiving layer is provided over (on or above) the undercoat layer and contain at least inorganic fine particles and a second water-soluble resin.

In embodiments, one or more intermediate layer(s) may be provided between the ink-receiving layer and the undercoat layer, although the ink-receiving layer and the undercoat layer may be preferably adjacent with each other.

Second Water-Soluble Resin

The ink-receiving layer contains a second water-soluble resin.

Examples of the second water-soluble resin include: resins having hydroxyl groups as hydrophilic structural units [e.g., polyvinyl alcohol (PVA), cation-modified polyvinyl alcohol, anion-modified polyvinyl alcohol, silanol-modified polyvinyl alcohol, and polyvinyl acetal], cellulose resins [e.g., methyl cellulose (MC), ethyl cellulose (EC), hydroxyethyl cellulose (HEC), carboxymethyl cellulose (CMC), and hydroxypropyl cellulose (HPC)], chitins, chitosans, and starch; resins containing hydrophilic ether bonds [e.g., polyethylene oxide (PEO), polypropylene oxide (PPO), polyethylene glycol (PEG), and polyvinyl ether (PVE)]; resins containing hydrophilic amide groups or amide bonds [e.g., polyacrylamide (PAAM) and polyvinyl pyrrolidone (PVP)], and resins containing carboxyl groups as dissociable groups (e.g., polyacrylic acid salts, maleic acid resins, and alginic acid salts).

In embodiments, the second water-soluble resin may be preferably polyvinyl alcohol in view of glossiness and ink absorbing property of the inkjet recording medium. Polyvinyl alcohol has hydroxyl groups in its structure units. Since the hydroxyl groups and the surface silanol groups on fumed silica form hydrogen bonds, a three-dimensional network structure containing secondary particles of the silica fine particles as chain units may be easily formed. The ink-receiving layer having a porous structure having high void ratio may be formed owing to the formation of the three-dimensional network structure. Because the thus-obtained ink-receiving layer having porous structure may rapidly absorb ink by capillary phenomenon, dots with excellent roundness may be formed without ink bleeding.

There is no particular limitation to the saponification degree of the polyvinyl alcohol. In embodiments, it may be in a range of from 80 mol % to 99.8 mol %, and may be preferably in a range of from 92 mol % to 98 mol %, and may be more preferably in a range of from 93 mol % to 97 mol %, in view of improving ink absorption property and stability in formation of the ink-receiving layer. There is no particular limitation to the average polymerization degree of the polyvinyl alcohol. In embodiments, it may be in a range of from 300 to 4500, and may be preferably in a range of from 1500 to 3600, and may be more preferably in a range of from 2000 to 3500, in view of suppressing cracking of the ink-receiving layer and improving stability in formation of the ink-receiving layer.

In embodiments, a mixture of one or more second water-soluble resins, such as a combination of polyvinyl alcohol and one or more water-soluble resin(s) which is/are other than polyvinyl alcohol, may be used. When a mixture of polyvinyl alcohol and one or more water-soluble resin(s) which is/are other than polyvinyl alcohol are used together, the sum of contents of the one or more water-soluble resin(s) which is/are other than polyvinyl alcohol may be preferably from 1% by mass to 30% by mass, more preferably from 3% by mass to 20% by mass, and further preferably from 6% by mass to 12% by mass, with respect to the sum of the contents of the polyvinyl alcohol and one or more water-soluble resin(s) which is/are other than polyvinyl alcohol.

In view of suppressing deterioration of film strength and generation of cracking of the ink-receiving layer under dried conditions which may be caused by insufficient content of the water-soluble resin, and in view of suppressing deterioration of ink absorption property of the ink-receiving layer caused by decrease of the void volume ratio due to clogging of the voids by the water-soluble resin which may be caused by excessive content of the water-soluble resin, the content of the second water-soluble resin in the ink-receiving layer may be preferably from 9% by mass to 40% by mass, and more preferably from 12% by mass to 33% by mass, with respect to the total solid content of the ink-receiving layer.

First Inorganic Fine Particles in Ink-Receiving Layer

The ink-receiving layer contains at least first inorganic fine particles. The inclusion of the first inorganic fine particles may provide a porous structure, which may facilitate to improve ink absorbing property, to the ink-receiving layer. In embodiments, the solid content of the first inorganic fine particles may be preferably from 50% by mass or more, and more preferably more than 60% by mass, with respect to the total solid content of the ink-receiving layer in view of forming further favorable porous structure which may facilitate to provide sufficient ink absorbing property to the inkjet recording medium. The “solid content of the first inorganic fine particles” herein means a value calculated based on contents of components which form the ink-receiving layer and are other than water.

Examples of the first inorganic fine particles include silica fine particles, colloidal silica, alumina fine particles, titanium dioxide, barium sulfate, calcium silicate, zeolite, kaolinite, halloysite, mica, talc, calcium carbonate, magnesium carbonate, calcium sulfate, pseudo-boehmite, zinc oxide, zinc hydroxide, alumina, aluminum silicate, calcium silicate, magnesium silicate, zirconium oxide, zirconium hydroxide, cerium oxide, lanthanum oxide and yttrium oxide. Of these, silica fine particles, colloidal silica, alumina fine particles and pseudo-boehmite may be preferable from the viewpoint of forming an excellent porous structure. The first inorganic fine particles may be used in the form of primary or secondary particles. The first inorganic fine particles may be inorganic fine particles of a single kind or may be a mixture of plural kinds of inorganic fine particles. In embodiments, silica fine particles with an average primary particle diameter of 20 nm or less, colloidal silica with an average primary particle diameter of 30 nm or less, alumina fine particles with an average primary particle diameter of 20 nm or less, and pseudo-boehmite with an average pore radius of 2 nm to 15 nm may be preferable, and such silica fine particles, such alumina fine particles and such pseudo-boehmite may be more preferable.

Silica Fine Particles

In general, silica fine particles are classified roughly into wet-method particles and dry-method (vapor-phase-method) particles depending on the production method therefor. In the wet method, generally, a silicate salt is decomposed with an acid to produce an active silica, and the active silica is polymerized to a suitable extent to cause aggregation-precipitatation to obtain hydrous silica. The vapor-phase methods are classified roughly into the flame hydrolysis process and the arc method. In the flame hydrolysis process, generally, a silicon halide is hydrolyzed in a vapor phase at high temperature to form anhydrous silica fine particles; and in the arc method, generally, quartz and coke are reduced and vaporized in an electric furnace by applying arc discharge, followed by air oxidation, to thereby form anhydrous silica fine particles. The “fumed silica” herein refers to anhydrous silica fine particles produced by the vapor-phase method. The silica fine particles used herein may be preferably fumed silica particles.

The fumed silica have different properties from the hydrous silica. For example, the f fumed silica contains voids unlike the hydrous silica, and they are also different in the density of silanol groups present on the surface. The fumed silica is suitable for forming a three-dimensional structure with high void volume ratio. The reason for this is supposed as follows: hydrous silica fine particles have a higher density of silanol groups present on their surfaces (about 5 groups to 8 groups/nm²), leading to dense gathering (aggregation); in contrast, fumed silica fine particles have a lower density of silanol groups present on their surfaces (about 2 groups to 3 groups/nm²), leading to loose gathering (flocculation) and thus forming a three-dimensional structure with high void volume ratio.

Since silica fine particles have an especially high specific surface area, an ink-receiving layer containing silica fine particles may efficiently absorb and retain ink. Further, because a refractive index of silica fine particles is low, an ink-receiving layer containing silica fine particles may be imparted with transparency, high color density and good coloring ability, provided that the silica fine particles are dispersed in the ink-receiving layer to have an adequate fine particle diameter. Such a transparency of the ink-receiving layer may be useful for obtaining high color density and good coloring ability and gloss, which may be desired in applications to a recording sheet such as a photoglossy paper as well as in applications requiring transparency such as OHP.

An average primary particle diameter of the fumed silica may be preferably 30 nm or less, more preferably 20 nm or less, further preferably 10 nm or less, and particularly preferably in a range of from 3 nm to 10 nm. The fumed silica fine particles are easier to stick to one another via hydrogen bonds formed by silanol groups, and those with an average primary particle diameter of 30 nm or less may form a structure having high void volume ratio which may effectively enhance ink-absorbability.

The fumed silica may be used in combination with the other inorganic fine particles. When the fumed silica is used in combination with the other inorganic fine particles, the content of the fumed silica may be preferably 30% by mass or more, and more preferably 50% by mass or more, with respective to the total content of all the fine particles in the ink-receiving layer.

Alumina Fine Particles (Pseudo-Boehmite)

Examples of the first inorganic fine particles further include alumina fine particles such as alumina hydrate. Alumina fine particles may be preferable in view of obtaining good ink-absorbability and ink-fixing property. Pseudo-boehmite (Al₂O₃.nH₂O) may be particularly preferable. Alumina hydrates in any one of various forms may be used. In embodiments, boehmite sol may be used in view of easiness in obtaining a smooth layer.

The pseudo-boehmite may preferably have an average pore radius of from 1 nm to 30 nm, more preferably from 2 nm to 15 nm; and preferably has a pore volume of from 0.3 cm³/g to 2.0 cm³/g, and more preferably from 0.5 cm³/g to 1.5 cm³/g. The pore radius and the pore volume are values measured using the nitrogen adsorption/desorption method, which may be performed by using a gas adsorption/desorption analyzer (e.g., trade name: OMNISOAP 369, manufactured by Coulter, Inc.).

Among alumina fine particles, vapor-phase-method alumina fine particles may be preferably used for large specific surface area thereof. The vapor-phase-method alumina fine particles may preferably have an average primary particle diameter of 30 nm or less, and more preferably 20 nm or less.

In embodiments, the ink-receiving layer may further contain organic fine particles as long as the effect achieved by the inkjet recording medium is not impaired.

Examples of the organic fine particles include polymer fine particles obtained by emulsion polymerization, micro emulsion polymerization, soap free polymerization, seed polymerization, dispersion polymerization, suspension polymerization or the like, and specific examples thereof include polymer fine particles of polyethylene, polypropylene, polystyrene, polyacrylate, polyamide, silicone resins, phenol resins, and natural high molecular compounds, which are in a state of powder, latex or emulsion.

The kind of the water-soluble resin may be selected in consideration of a combination of the fine particles (specifically, silica fine particles) and the water-soluble resin since it may affect the transparency of the inkjet recording medium. The second water-soluble resin may be preferably polyvinyl alcohol when fumed silica is used as the first inorganic fine particles. The preferable range of the saponification degree of the polyvinyl alcohol is explained above.

Polyvinyl alcohol has hydroxyl groups in its structure units. Since the hydroxyl groups and the surface silanol groups on the silica fine particles form hydrogen bonds, a three-dimensional network structure containing secondary particles of the silica fine particles as chain units may be easily formed. The ink-receiving layer having a porous structure having high void ratio may be formed owing to the formation of the three-dimensional network structure. Because the thus-obtained ink-receiving layer having porous structure may rapidly absorb ink by capillary phenomenon, dots with excellent roundness may be formed by inkjet recording without ink bleeding.

Content Ratio of First Inorganic Fine Particles to Second Water-Soluble Resin

A mass ratio of the content of the first inorganic fine particles (x) to the content of the second water-soluble resin (y) (PB ratio (x/y)) in the ink-receiving layer may be preferably 3 or more.

The film structure of the ink-receiving layer may depend on the PB ratio. In general, as the PB ratio increases, the void volume ratio, pore volume and surface area (per unit mass) of the ink-receiving layer also increase. The PB ratio may be 3 or more in view of suppressing deterioration of ink absorption property caused by decrease of the void volume ratio due to clogging of the voids by the water-soluble resin which may be caused by excessively small PB ratio.

In the ink-receiving layer, the PB ratio may be preferably 10 or less, in view of suppressing deterioration in the color density and the brittleness-resistance of the inkjet recording medium which may be caused due to excessively large PB ratio.

The ink-receiving layer may be required to have sufficiently high film strength. This is because a stress may be applied thereto during transfer of the inkjet recording medium through a conveying system, and because cracking, peeling, and the like of the ink-receiving layer may occur when the inkjet-recording medium is cut into sheets. Considering these, the PB ratio is preferably 6 or less. From the viewpoint of ensuring high-speed ink absorbability when the inkjet-recording medium is used in inkjet printers, the ratio may be preferably 4 or more.

For example, in the case where fumed silica fine particles with an average primary particle diameter of 20 nm or less being used as the first inorganic fine particles and a water-soluble resin being used as the second water-soluble resin are homogeneously dispersed in an aqueous solution at the PB ratio (x/y) of 3/1 to 10/1 to prepare a coating liquid, and the coating liquid is coated on a non-water-absorptive support, followed by drying, a three-dimensional network structure having, as the network (chain) structure unit, secondary particles of the silica fine particles is formed. Thus, there can be easily formed a translucent porous film with an average pore diameter of 30 nm or less, void volume ratio of from 50% to 80%, specific pore volume of 0.5 mL/g or more, and specific surface area of 100 m²/g or larger.

Other Component of Ink-Receiving Layer

The ink-receiving layer may further contain, in addition to the second water-soluble resin and the first inorganic fine particles, a crosslinking agent, an aluminum hydroxide compound, a zirconium compound and/or the like, as long as the effect achieved by the inkjet recording medium is not impaired.

Crosslinking Agent

The ink-receiving layer may contain a crosslinking agent in view of improving strength of the ink-receiving layer (brittleness resistance). In embodiments, the ink-receiving layer may be preferably a porous layer cured by the crosslinking reaction between the crosslinking agent and the water-soluble resin.

The crosslinking agent may be selected with taking a relationship between the crosslinking agent and the water-soluble resin into account. For example, when the water-soluble resin is polyvinyl alcohol, the crosslinking agent may be preferably a boron compound in view of rapidly progressing crosslinking reaction. Examples of the boron compound include borax, boric acid, boric acid salts (e.g., orthoboric acid salt, InBO₃, ScBO₃, YBO₃, LaBO₃, Mg₃(BO₃)₂, and CO₃(BO₃)₂), diboric acid salts (e.g., Mg₂B₂O₅ and CO₂B₂O₅), metaboric acid salts (e.g., LiBO₂, Ca(BO₂)₂, NaBO₂, and KBO₂), tetraboric acid salts (e.g., Na₂B₄O₇.10H₂O) and pentaboric acid salts (e.g., KB₅O₈.4H₂O, Ca₂B₆O₁₁.7H₂O, and CsB₅O₅). Borax, boric acid, and boric acid salts may be preferable, and boric acid may be more preferable, in view of rapidly progressing crosslinking reaction. In embodiments, these may be preferably used in combination with polyvinyl alcohol which is used as the water-soluble resin.

The amount of the crosslinking agent to be used may be preferably from 0.05 parts by mass to 50 parts by mass, and more preferably from 0.08 parts by mass to 40 parts by mass, with respect to 1 part by mass of the weight of polyvinyl alcohol in the ink-receiving layer. The polyvinyl alcohol may be effectively crosslinked to suppress cracking and the like when the amount of the crosslinking agent is within such range.

Examples of the crosslinking agent which is other than a boron compound and may be used when gelatin or the like is used as the second water-soluble resin include: aldehyde compounds such as formaldehyde, glyoxal, and glutaraldehyde; ketone compounds such as diacetyl and chloropentanedione; reactive halogen compounds, such as bis (2-chloroethylurea)-2-hydroxy-4,6-dichloro-1,3,5-triazine and a sodium salt of 2,4-dichloro-6-s-triazine; reactive vinyl compounds, such as divinyl sulfonic acid, 1,3-vinylsulfonyl-2-propanol, N,N′-ethylenebis(vinylsulfonylacetamide), and 1,3,5-triacryloyl-hexahydro-s-triazine; N-methylol compounds such as dimethylol urea and methyloldimethylhydantoin; melamine resins (e.g., methylol melamine and alkylated methylol melamine); epoxy resins;

isocyanate compounds such as 1,6-hexamethylene diisocyanate; aziridine compounds described in U.S. Pat. Nos. 3,017,280 and 2,983,611; carboxylmide compounds described in U.S. Pat. No. 3,100,704; epoxy compounds such as glycerol triglycidyl ether; ethyleneimino compounds such as 1,6-hexamethylene-N,N′-bisethylene urea; halogenated carboxy aldehyde compounds such as mucochloric acid and mucophenoxychloric acid; dioxane compounds such as 2,3-dihydroxy dioxane; metal-containing compounds such as titanium lactate, aluminum sulfate, chrome alum, potassium alum, zirconyl acetate and chrome acetate, polyamine compounds such as tetraethylenepentamine, hydrazide compounds such as adipic dihydrazide, low molecular compounds each containing at least two oxazoline groups, and polymers each containing at least two oxazoline groups. Only one crosslinking agent may be used, or two or more crosslinking agents may be used in combination.

Water-Soluble Aluminum Compound

In embodiments, the ink-receiving layer may preferably contain a water-soluble aluminum compound. The use of the water-soluble aluminum compound may facilitate to improve water resistance and to suppress blurring upon time passage of images formed on the inkjet recording layer.

Examples of the water-soluble aluminum compound include an inorganic aluminum salt. Examples of the inorganic aluminum salt include aluminum chloride, hydrates of aluminum chloride, aluminum sulfate, hydrates of aluminum sulfate, and aluminum alum. Examples of the water-soluble aluminum compound further include a basic polyaluminum hydroxide compound, which is an inorganic aluminum-containing cationic polymer. Among these, the basic polyaluminum hydroxide compound may be preferably used.

The basic polyaluminum hydroxide compound is a water-soluble polyaluminum hydroxide compound having a main component represented by the following Formula 1, 2 or 3. Accordingly, the basic polyaluminum hydroxide compound stably contains a basic polymeric polynuclear condensed ion such as [Al₆(OH)₁₅]³⁺, [Al₈(OH)₂₀]⁴⁺, [Al₁₃(OH)₃₄]⁵⁺ or [Al₂₁(OH)₆₀]³⁺.

Formula 1: [Al₂(OH)nCl₆₋ₙ]m (5<m<80, and 1<n<5)
Formula 2: [Al(OH)₃]ₙAlCl₃ (1<n<2)
Formula 3: Alₙ(OH)ₘCl₍₃ₙ₋ₘ₎ (0<m<3n, and 5<m<8)

These compounds are commercially available as a water-treatment agent. Examples of such water-treatment agent include POLY(ALUMINUM CHLORIDE) (PAC) (trade name, available from Taki Kagaku Co., Ltd.), POLY(ALUMINUM HYDROXIDE) (PAHO) (trade name, available from Asada Kagaku KK), and PURACHEM WT (trade name, available from Riken Green KK). Such compounds are also produced by other manufacturers with a similar object, and various grades agents thereof are readily available. There are some commercial product of the water-treatment agent which have unsuitably low pH. pH of such water-treatment agent products having low pH may be appropriately adjusted when they are used.

The “water-soluble” herein means a property of a material which can be dissolved in water at a concentration of 1% by mass or more under ordinary temperature and ordinary pressure.

The content of the water-soluble aluminum compound in the ink-receiving layer may be preferably from 0.1% by mass to 20% by mass, more preferably from 1% by mass to 8% by mass, and further preferably from 2% by mass to 4% by mass, with respect to the total amount of all solid components of the ink-receiving layer. When the content of the water-soluble aluminum compound is in the range of from 2% by mass to 4% by mass, glossiness, water resistance, gas resistance, and light fastness of the inkjet recording medium may be improved.

Zirconium Compound

In embodiments, the ink-receiving layer may preferably contain a zirconium compound. The use of a zirconium compound may facilitate to increase water resistance.

The zirconium compound herein used is not particularly limited, and examples thereof include zirconyl acetate, zirconium chloride, zirconium oxychloride, zirconium hydroxychloride, zirconium nitrate, basic zirconium carbonate, zirconium hydroxide, ammonium zirconium carbonate, potassium zirconium carbonate, zirconium sulfate, and zirconium fluoride. In embodiments, zirconyl acetate may be more preferably used.

The content of the zirconium compound in the total solid content of the ink-receiving layer may be preferably 0.05% by mass to 5.0% by mass, more preferably 0.1% to 3.0% by mass, and most preferably 0.5% to 2.0% by mass. When the content of the zirconium compound is within the range of 0.5% to 2.0% by mass, the water resistance may be improved without deteriorating ink absorbency.

A water-soluble polyvalent metal compound which is other than the water-soluble aluminum compound and the zirconium compound may be used. Examples of such water-soluble polyvalent metal compound include water-soluble salts of a metal selected from calcium, barium, manganese, copper, cobalt, nickel, iron, zinc, chromium, magnesium, tungsten, and molybdenum.

Specific examples of such water-soluble polyvalent metal compound include calcium acetate, calcium chloride, calcium formate, calcium sulfate, barium acetate, barium sulfate, barium phosphate, manganese chloride, manganese acetate, manganese formate dihydrate, manganese ammonium sulfate hexahydrate, cupric chloride, copper (II) ammonium chloride dihydrate, copper sulfate, cobalt chloride, cobalt thiocyanate, cobalt sulfate, nickel sulfate hexahydrate, nickel chloride hexahydrate, nickel acetate tetrahydrate, nickel ammonium sulfate hexahydrate, nickel amidosulfate tetrahydrate, ferrous bromide, ferrous chloride, ferric chloride, ferrous sulfate, ferric sulfate, zinc bromide, zinc chloride, zinc nitrate hexahydrate, zinc sulfate, chromium acetate, chromium sulfate, magnesium sulfate, magnesium chloride hexahydrate, magnesium citrate nonahydrate, sodium phosphotungstate, tungsten sodium citrate, 12-tungstophosphoric acid n-hydrate, 12-tungstosilicic acid 26-hydrate, molybdenum chloride, and 12-molybdophosphoric acid n-hydrate.

Other Components

The ink-receiving layer may further contain the following components if necessary.

The ink-receiving layer may contain an anti-fading agent such as an ultraviolet absorber, an antioxidant, or a singlet oxygen quencher to suppress the deterioration of a color material in an ink.

Examples of the ultraviolet absorber include a cinnamic acid derivative, a benzophenone derivative, and a benzotriazolylphenol derivative. Examples thereof include butyl α-cyanophenylcinnamate, o-benzotriazole phenol, o-benzotriazole-p-chlorophenol, o-benzotriazole-2,4-di-t-butylphenol, and o-benzotriazole-2,4-di-t-octylphenol. Examples of the ultraviolet absorber further include a hindered phenol compound, and specific preferable examples thereof include a phenol derivative having a branched alkyl group as a substituent at at least one of 2- and 6-positions.

Examples of the ultraviolet absorber further include a benzotriazole ultraviolet absorber, a salicylic acid ultraviolet absorber, a cyano acrylate ultraviolet absorber, and an oxalic acid anilide ultraviolet absorber. Such ultraviolet absorbers are described in Nos. 47-10537, 58-111942, 58-212844, 59-19945, 59-46646, 59-109055, and 63-53544, JP-B Nos. 36-10466, 42-26187, 48-30492, 48-31255, 48-41572, 48-54965, and 50-10726, and U.S. Pat. Nos. 2,719,086, 3,707,375, 3,754,919, and 4,220,711.

A fluorescent whitening agent may also be used as the ultraviolet absorber. Examples thereof include a coumarin-based agent. Specific examples thereof include those described in JP-B Nos. 45-4699 and 54-5324.

Examples of the antioxidant include those described in EP-A Nos. 223739, 309401, 309402, 310551, 310552, and 459-416, DE-A No. 3,435,443, JP-A Nos. 54-48535, 60-107384, 60-107383, 60-125470, 60-125471, 60-125472, 60-287485, 60-287486, 60-287487, 60-287488, 61-160287, 61-185483, 61-211079, 62-146678, 62-146680, 62-146679, 62-282885, 62-262047, 63-051174, 63-89877, 63-88380, 66-88381, 63-113536, 63-163351, 63-203372, 63-224989, 63-251282, 63-267594, 63-182484, 1-239282, 2-262654, 2-71262, 3-121449, 4-291685, 4-291684, 5-61166, 5-119449, 5-188687, 5-188686, 5-110490, 5-1108437, and 5-170361, JP-B Nos. 48-43295 and 48-33212, and U.S. Pat. Nos. 4,814,262 and 4,980,275.

Specific examples of the antioxidants include 6-ethoxy-1-phenyl-2,2,4-trimethyl-1,2-dihydroquinoline, 6-ethoxy-1-octyl-2,2,4-trimethyl-1,2-dihydroquinoline, 6-ethoxy-1-phenyl-2,2,4-trimethyl-1,2,3,4-tetrahydroquinoline, 6-ethoxy-1-octyl-2,2,4-trimethyl-1,2,3,4-tetrahydroquinoline, nickel cyclohexane-butyrate, 2,2-bis(4-hydroxyphenyl)propane, 1,1-bis(4-hydroxyphenyl)-2-ethylhexane, 2-methyl-4-methoxy-diphenylamine, and 1-methyl-2-phenylindole.

These anti-fading agents may be used singly or in combination of two or more. The anti-fading agent may be water-solubilized, dispersed, or emulsified, and may be contained in a microcapsule. The content of the anti-fading agent in a liquid for forming the ink-receiving layer is preferably from 0.01% by mass to 10% by mass.

In embodiments, the ink-receiving layer may contain a high-boiling organic solvent for suppressing curling. The high-boiling organic solvent may be preferably water soluble. Examples of the water-soluble high-boiling organic solvent include alcohol compounds such as ethylene glycol, propylene glycol, diethylene glycol, triethylene glycol, glycerin, diethylene glycol monobutyl ether (DEGMBE), triethylene glycol monobutyl ether, glycerin monomethyl ether, 1,2,3-butanetriol, 1,2,4-butanetriol, 1,2,4-pentanetriol, 1,2,6-hexanetriol, thiodiglycol, triethanolamine, and polyethylene glycols having a weight-average molecular weight of 400 or less. The high-boiling organic solvent may be preferably diethylene glycol monobutyl ether (DEGMBE).

The content of the high-boiling organic solvent in a liquid for forming the ink-receiving layer may be preferably from 0.05% by mass to 1% by mass, and more preferably from 0.1% by mass to 0.6% by mass.

The ink-receiving layer may further contain an inorganic salt for improving dispersing property of the first inorganic fine particles, and may further contain an acid or an alkali as a pH adjuster.

The ink-receiving layer may further contain an electron-conductive metal oxide particle for suppressing frictional electrification or peeling electrification of the surface. The ink-receiving layer may further contain a mattifying agent for reducing surface friction.

Non-Water-Absorptive Support

The non-water-absorptive support may be a transparent support containing a transparent material such as a plastic or an opaque support containing opaque material such as paper. In embodiments, the non-water-absorptive support may be preferably a transparent support or an opaque support having a high glossiness in view of taking advantage of transparency of the ink-receiving layer. In embodiments, a read-only optical disc such as CD-ROM or DVD-ROM, a recordable optical disc such as CD-R or DVD-R, or a rewritable optical disc may be used as the support, the ink-receiving layer being formed on the label surface.

The “non-water-absorptive” property herein means a property showing the Cobb water absorptiveness of 1 g/m² or less.

In embodiments, the transparent support may be preferably formed of a transparent material capable of enduring radiant heat applied during use in OHPs and backlight displays. Examples of the material include polyesters (e.g., polyethylene terephthalate (PET)), polysulfones, polyphenylene oxides, polyimides, polycarbonates and polyamides. Among these, polyesters may be preferable, and polyethylene terephthalate may be more preferable.

The thickness of the transparent support is not particularly limited. In embodiments, it may be preferably from 50 μm to 200 μm in view of easy handling.

The opaque and high-gloss support is preferably those where the surface on which the ink-receiving layer is to be formed has a glossiness of 40% or higher. The glossiness is a value determined according to the method described in JIS P-8142 (test method for specular gloss of paper and paperboard at 75°), the disclosure of which is herein incorporated by reference.

Specific examples of the opaque and high-gloss support include: high-gloss paper supports such as art paper, coat paper, cast coat paper and baryta paper used for a silver-halide photographic support; opaque, high-gloss films prepared by incorporating white pigment or the like into plastic films formed, for example, of polyesters (e.g., polyethylene terephthalate (PET)), polysulfones, polyphenylene oxides, polyimides, polycarbonates or polyamides (the films being optionally subjected to a surface calender treatment); and water non-absorptive supports prepared by providing, onto the surface of the transparent supports or high-gloss films containing white pigment or the like, a coating layer made of polyolefin which may contain or not contain a white pigment. Specific examples thereof further include white pigment-containing foamed polyester films (e.g., foamed PET containing polyolefin fine particles and voids formed through stretching) and resin-coated paper used for silver-halide photographic printing paper.

The thickness of the opaque support is not particularly limited. In embodiments, it may be preferably from 50 μm to 300 μm from the viewpoint of handleability.

In embodiments, the surface of the non-water-absorptive support may be treated with, for example, a corona discharge treatment, glow discharge treatment, flame treatment or UV ray irradiation treatment in view of improving wettability and adhesiveness.

Raw paper may be used for paper supports such as the resin-coated paper. The raw paper is made from a mixture mainly containing wood pulp and optionally containing synthetic pulp (e.g., polypropylene) and/or synthetic fiber (e.g., nylon and polyester). Examples of the wood pulp include LBKP, LBSP, NBKP, NBSP, LDP, NDP, LUKP and NUKP. In embodiments, the wood pulp mixture may preferably contain a larger amount of LBKP, NBSP, LBSP, NDP and/or LDP, each containing a lot of short fibers. The relative LBSP and/or LDP amount with respect to the mixture may be preferably from 10% by mass to 70% by mass.

Chemical pulp, which contains few impurities, may be preferably used for forming the raw paper, and examples thereof include a sulfuric acid salt pulp and a sulfinic acid salt pulp. Bleached pulp with improved whiteness may also be used. The raw paper may appropriately further contain, for example, a sizing agent (e.g., higher fatty acids and alkyl ketene dimers), a white pigment (e.g., calcium carbonate, talc and titanium oxide), a paper strengthening agent (e.g., starch, polyacrylamide and polyvinyl alcohol), a fluorescent whitening agent, a water retention agent (e.g., polyethylene glycols), a dispersant, and/or a softening agent (e.g., quaternary ammoniums).

In embodiments, the freeness of the pulp used for papermaking may be preferably from 200 mL to 500 mL according to the CSF. In embodiments, the pulp obtained after beating may preferably have a fiber length (as measured according to JIS P-8207, the disclosure of which is herein incorporated by reference) satisfying the following: a total of a 24-mesh-screen-remnant and a 42-mesh-screen-remnant is from 30% by mass to 70% by mass, and a 4-mesh-screen-remnant is 20% by mass or less.

In embodiments, the basis weight of the raw paper may be preferably from 30 g/m² to 250 g/m², and more preferably from 50 g/m² to 200 g/m². The thickness of the raw paper may be preferably 40 μm to 250 μm. The raw paper may be provided with high smoothness by performing a calender treatment during or after papermaking. The density of the raw paper may is generally from 0.7 g/m² to 1.2 g/m² as measured according to JIS P-8118, the disclosure of which is herein incorporated by reference. The strength of the raw paper may be preferably from 20 g to 200 g as measured according to JIS P-8143, the disclosure of which is herein incorporated by reference.

The surface of the raw paper may be coated with a surface-sizing agent. Examples of the surface-sizing agent include those which can be incorporated into the raw paper.

In embodiments, the pH of the raw paper may be from 5 to 9 as measured by a hot-water extraction method according to JIS P-8113, the disclosure of which is herein incorporated by reference.

The front and back surfaces of the raw paper may be coated with polyethylene to form polyethylene-coated paper. Low-density polyethylene (LDPE) and/or high-density polyethylene (HDPE) may be used as the polyethylene in many cases, although other LLDPE or other polypropylene may also be partly used therefor.

In embodiments, the polyethylene layer provided on the side where the ink-receiving layer is to be formed may be preferably made from polyethylene to which rutile- or anatase-type titanium oxide, a fluorescent whitening agent and/or an ultramarine blue pigment is added as is widely performed for forming photographic printing paper in view of improving opaqueness, whiteness and hue. The content of the titanium oxide with respect to the amount of polyethylene may be preferably from about 3% by mass to about 20% by mass, and more preferably from 4% by mass to 13% by mass. The thickness of the polyethylene layers which may be provided on the front and/or back surface(s) is not respectively particularly limited. In embodiments, the thicknesses may be respectively preferably from 10 μm to 50 μm.

The polyethylene-coated paper may be used as gloss paper. Alternatively, like general-use photographic printing paper, it may be provided with a matte surface or a silk-finish surface by subjecting it to an embossing treatment when polyethylene is melt-extruded onto the raw paper surface.

In embodiments, the non-water-absorptive support may be provided with a back-coat layer. The back-coat layer may contain a white pigment, an aqueous binder, and/or other components.

Examples of the white pigment which may be contained in the back-coat layer include inorganic white pigments such as light calcium carbonate, heavy calcium carbonate, kaolin, talc, calcium sulfate, barium sulfate, titanium dioxide, zinc oxide, zinc sulfide, zinc carbonate, satin white, aluminum silicate, diatomaceous earth, calcium silicate, magnesium silicate, synthetic amorphous silica, colloidal silica, colloidal alumina, pseudo-boehmite, aluminum hydroxide, alumina, lithopone, zeolite, hydrated halloysite, magnesium carbonate and magnesium hydroxide; and organic pigments such as styrene plastic pigments, acrylic plastic pigments, polyethylene, microcapsules, urea resins and melamine resins.

Examples of the aqueous binder which may be contained in the back-coat layer include water-soluble polymers such as styrene/maleic acid salt copolymers, styrene/acrylic acid salt copolymers, polyvinyl alcohol, silanol-modified polyvinyl alcohol, starch, cationic starch, casein, gelatin, carboxymethyl cellulose, hydroxyethyl cellulose and polyvinyl pyrrolidone; and water-dispersible polymers such as styrene-butadiene latex and acrylic emulsion. Examples of the other components which may be contained in the back-coat layer include defoamers, foaming-suppressing agents, dyes, fluorescent whitening agents, antiseptic agents and water-proofing agents.

Method of Producing Inkjet Recording Medium

The inkjet recording medium may be produced by, for example, a method including: coating the undercoat layer forming liquid on the non-water-absorptive support; drying the coated undercoat layer forming liquid to form the undercoat layer; at the same time or after the coating of the undercoat layer forming liquid, coating, on the undercoat layer, an ink-receiving layer forming liquid that contains at least the first inorganic fine particles and the second water-soluble resin; and drying the coated ink-receiving layer forming liquid.

The ink-receiving layer forming liquid may be prepared by, for example, dispersing silica fine particles and a zirconium compound by subjecting these to counter collision by using a high-pressure disperser, or having passing these through an orifice so as to prepare a dispersion liquid of the silica fine particles; and adding the second water-soluble resin to the dispersion liquid.

The dispersion liquid that is obtained by counter collision of the silica fine particles and zirconium compound with the high pressure disperser or by passing them through the orifice may be excellent in terms of fine particle diameter of the first inorganic fine particles.

The silica fine particles and the zirconium compound may be respectively prepared in a form of a pre-dispersion (a dispersion containing the silica fine particles or the zirconium compound) and subjected to the high-pressure disperser. Pre-mixing (pre-dispersing) for preparing these pre-dispersions may be performed by usual screw stirring, turbine stirring, homomixer stirring or the like.

Examples of the high-pressure disperser include a commercially-available apparatus which is generally called as a high-pressure homogenizer. Typical examples of the high-pressure homogenizer include NANOMIZER (trade name, manufactured by Nanomizer), MICROFLUIDIZER (trade name, manufactured by Microfluidix), and ALTIMIZER (trade name, manufactured by Sugino Machine Incorporated).

The “orifice” refers to a member having a mechanism in which a thin plate (orifice plate) having a minute hole (the shape thereof may be a circle or the like) is disposed in a straight pipe to rapidly reduce the sectional area of the flow path in the straight pipe.

The high-pressure homogenizer basically has a high-pressure generating part that pressurizes a starting slurry and the like and a counter collision part or an orifice part. In embodiments, a high-pressure pump which is generally called a plunger pump may be used advantageously as the high-pressure generating part. There are various high-pressure pumps, such as high-pressure pumps of single-line, double-line and triple-line systems, any of which can be used without particular limitation.

The processing pressure for the high-pressure counter collision described above may be 50 MPa or more, preferably 100 MPa or more, and more preferably 130 MPa or more. The difference between the pressure at the entry-side and that at the exit-side of the orifice, upon passage of the starting slurry, may also be 50 MPa or more, preferably 100 MPa or more, and more preferably 130 MPa or more.

The collision velocity of the pre-dispersions subjected to the counter collision may be preferably 50 m/second or more, more preferably 100 m/second or more, and further preferably 150 m/second or more, in terms of relative velocity.

The linear velocity of the pre-dispersions subjected to dispersing by passing through an orifice may be, similarly to the case of the counter collision, preferably 50 m/second or more, more preferably 100 m/second or more, and further preferably 150 m/second or more, in terms of relative velocity, while it cannot not generally determined because it may depend on the hole diameter of the orifice.

The dispersing efficiency in each method may depend on the processing pressure, and thus the dispersion efficiency may be increased as the processing pressure is increased. When the processing pressure is higher than 350 MPa, however, the pressure resistance of the piping of the high-pressure pump, the durability of the apparatus and the like may be affected.

In each method, the number of times of performing the dispersing treatment is not particularly limited. It may be usually suitably selected from the range of from 1 to several tens times. The dispersion liquid may thereby be obtained.

Various additives may also be added during the preparation of the dispersion liquid.

Examples of the additives include a wide variety of nonionic or cationic surfactants (anionic surfactants may not be preferable because they form aggregates), defoaming agents, nonionic hydrophilic polymers (e.g., polyvinyl alcohol, polyvinyl pyrrolidone, polyethylene oxide, polyacrylamide, various sugars, gelatin, and pullulan), nonionic or cationic latex dispersion liquids, water-miscible organic solvents (e.g., ethyl acetate, methanol, ethanol, isopropanol, n-propanol, and acetone), inorganic salts, and pH adjusting agents. These agents can be used as necessary.

In embodiments, a water-miscible organic solvent may be preferable since it may suppress the formation of fine aggregates during the preliminarily dispersing treatment of the silica fine particles. The water-miscible organic solvent may be used preferably in an amount of from 0.1 wt % to 20 wt %, and more preferably from 0.5 wt % to 10 wt %, with respect to the amount of the dispersion liquid.

The pH value at the preparation of the silica fine particle dispersion liquid may be varied widely depending on the type of the silica fine particles, various additives, and the like. In general, the pH value may be preferably from 1 to 8, and more preferably from 2 to 7. In embodiments, two or more of dispersing methods selected from the above dispersing methods may be employed.

The ink-receiving layer forming liquid may be prepared by adding the second water-soluble resin and the like to the thus-formed silica fine particle dispersion liquid. The mixing of the silica fine particle dispersion liquid and the second water-soluble resin and the like may be performed by usual screw stirring, turbine stirring, homomixer stirring or the like.

In embodiments, the water-soluble aluminum compound may be added to the ink-receiving layer forming liquid by in-line mixing. Examples of an in-line mixer used therefor include, but are not limited to, that described in JP-A No. 2002-85948.

The ink-receiving layer of the inkjet receiving medium may be formed by a method which includes: applying, onto an undercoat layer of a non-water absorbing support, the undercoat layer being provided by coating and drying an undercoat layer coating liquid in advance, a coating liquid (coating liquid A) which is formed by in-line mixing the ink-receiving layer forming liquid with the water-soluble aluminum compound; applying a basic solution of pH 7.1 or higher onto the coated layer either (1) simultaneously with the application of the coating liquid A or (2) during the drying of the coated layer formed by the application of the coating liquid A but before the coated layer shows a decreasing rate of drying; and then curing and crosslinking the resulting coated layer. When the ink-receiving layer is formed by curing and crosslinking in this manner, the ink absorbing property may be improved and cracking of the layer can be suppressed.

The solvents for the preparation of the respective liquids for forming the ink-receiving layer may be selected from water, organic solvents, and mixed solvents thereof. Examples of organic solvents usable for coating include alcohols such as methanol, ethanol, n-propanol, i-propanol and methoxy propanol, ketones such as acetone and methyl ethyl ketone, tetrahydrofuran, acetonitrile, ethyl acetate, and toluene.

The method for coating the coating liquid is not particularly limited, and may be selected from known coating methods. Examples of usable instruments include an extrusion die coater, an air doctor coater, a bread coater, a rod coater, a knife coater, a squeeze coater, a reverse roll coater, and a bar coater.

The basic solution having a pH value of 7.1 or higher may be applied either simultaneously with the application of the ink-receiving layer forming liquid or during the drying of the coated layer formed by the application of the ink-receiving layer forming liquid but before the coated layer shows a decreasing rate of drying. That is, the ink-receiving layer may be preferably produced by introducing the basic solution having a pH value of 7.1 or higher during the period in which the coated layer shows a constant rate of drying after applying the ink-receiving layer forming liquid.

The basic solution having a pH value of 7.1 or higher may contain a crosslinking agent and/or a mordant as necessary. The pH value of the basic solution is 7.1 or higher, preferably 7.5 or higher, and more preferably 8.0 or higher. When the pH value is 7.1 or higher, the crosslinking agent may sufficiently promote the crosslinking reaction of the water-soluble polymer contained in the coating liquid A. When the pH value is too nearly acidic value, the crosslinking agent may not be sufficiently promote the crosslinking reaction of polyvinyl alcohol contained in the coating liquid A, thus generating bronzing, cracking on the ink-receiving layer or the like.

The basic solution having a pH value of 7.1 or higher may be prepared, for example, by adding a metal compound (for example, 1% to 5%) and a base compound (for example, 1% to 5%), and optionally para-toluenesulfonic acid (for example, 0.5% to 3%), to ion-exchanged water and then stirring the mixture sufficiently. The“%” in each formulation herein refers to % by weight of solids content.

The expression “before the coated layer exhibits a decreasing rate of drying” usually refers to the period within a few minutes from the completion of the application of the ink-receiving layer forming liquid. During the period, the coated layer exhibits a constant rate of drying in which the quantity of the solvent (dispersing medium) contained in the coated layer decreases in proportion to time. For instance, the period during which the coated layer exhibits a “constant rate of drying” is described in Chemical Engineering Handbook (pp. 707-712, Maruzen Co., Ltd., Oct. 25, 1980).

After coating of the ink-receiving layer forming liquid, the coated layer is dried until the coated layer exhibits a decreasing rate of drying. In general, the coated layer is dried at a temperature of from 40° C. to 180° C. (preferably, at a temperature of from 50° C. to 120° C.) for a period of from 0.5 minutes to 10 minutes (preferably, from 0.5 minutes to 5 minutes). This drying time may be usually suitable though the drying time naturally depends on the coating amount.

### EXAMPLES

Hereinafter, specific embodiments are described in more detail by reference to Examples, but Examples should not be construed as limiting the invention. In Examples, the terms “parts” and “%” refer to “parts by weight” and “% by weight”, respectively.

Preparation of Support

50 parts of LBKP made from Acasia and 50 parts of LBKP made from Aspen were respectively refined by a disk refiner to a Canadian freeness of 300 mL to prepare a pulp slurry. To the pulp slurry were added 1.3% of a cationic starch (trade name: CATO 304L, available from Nippon NSC Ltd.), 0.15% of an anionic polyacrylamide (trade name: POLYACRON ST-13, available from Seiko PMC Corporation), 0.29% of an alkyl ketene dimer (trade name: SIZEPINE K, available from Arakawa Chemical Industries, Ltd.), 0.29% of an epoxidized behenic amide, and 0.32% of a polyamide polyamine epichlorohydrin (trade name: ARAFIX 100, available from Arakawa Chemical Industries, Ltd.), and thereto was further added 0.12% of an antifoaming agent. The ratios were based on the mass of the pulp.

The resultant pulp slurry was subjected to paper-making by a fourdrinier paper machine, and then dried. In the drying, the felt surface of the web was pressed against a drum dryer cylinder via a dryer canvas, the tensile force of the dryer canvas being adjusted to 1.6 kg/cm. Then, polyvinyl alcohol (trade name: KL-118, available from Kuraray Co., Ltd.) was applied at 1 g/m² to both the surfaces of the base paper by a size press, and the applied polyvinyl alcohol was dried and subjected to a calender treatment. The base paper (the raw paper) had a basis weight of 166 g/m² and a thickness of 160 μm.

The wire surface (back surface) of the resultant base paper was subjected to a corona discharge treatment and then coated with a high-density polyethylene to a thickness of 25 μm by a melt extrusion machine, so that a resin layer having a matte surface (hereinafter, the surface of the thermoplastic resin layer is referred to as “back surface”) was formed. The resin layer forming the back surface was further subjected to a corona discharge treatment and then coated, in an amount of 0.2 g/m² on a dry weight basis, with a dispersion liquid containing, as an antistatic agent, aluminum oxide (trade name: ALUMNA SOL 100, manufactured by Nissan Chemical Industries, Ltd.) and colloidal silicon dioxide (trade name: SNOWTEX O, manufactured by Nissan Chemical Industries, Ltd.) in the ratio of 1:2 (ratio by weight) dispersed in water.

The felt surface (front surface) not having the thermoplastic resin layer was subjected to a corona discharge treatment, and then a low-density polyethylene having a MRF (melt flow rate) of 3.8 by being prepared to contain 10% of anatase-type titanium dioxide, 0.3% of ultramarine manufactured by Tokyo Printing Ink Mfg. Co., Ltd., and 0.08% of a fluorescent brightener (trade name: WHITEFLOUR PSN CONC, manufactured by Nippon chemical works Co., Ltd.) was melt-extruded to a thickness of 25 μm onto the felt surface by a melt extrusion machine, to form a highly glossy thermoplastic resin layer on the front surface of the base paper (hereinafter, this highly glossy surface is referred to as a “front surface”). A water-resistant support was thus obtained. The water-resistant support was made into a long roll body having a width of 1.5 m and a wound length of 3000 m as a support H having no undercoat layer.

Preparation of Undercoat Layer Forming Liquids A to H

Undercoat layer forming liquids A to H were prepared by mixing and dispersing the mixture having the following formulation using a dissolver respectively.

Formulation of Undercoat layer forming liquid A

| | |
|---|---|
| (1) Ion-exchange water | 745 parts |
| (2) Water-soluble polyvinyl acetal solution (trade | 250 parts |
| name: S-LEK KW-3 (20%), manufactured by Sekisui | |
| Chemical Co., Ltd.) | |
| (3) Surfactant (trade name: EMULGEN 109P, manufactured | 5 parts |
| by Kao Corporation) | |

Formulation of Undercoat Layer Forming Liquid B

| | |
|---|---|
| (1) Ion-exchange water | 970 parts |
| (2) Water-soluble polyvinyl acetal solution (trade | 25 parts |
| name: S-LEK KW-3 (20%), manufactured by Sekisui | |
| Chemical Co., Ltd.) | |
| (3) Surfactant (trade name: EMULGEN 109P, manufactured | 5 parts |
| by Kao Corporation) | |

Formulation of Undercoat Layer Forming Liquid C

| | |
|---|---|
| (1) Ion-exchange water | 787 parts |
| (2) Water-soluble polyvinyl acetal solution (trade | 208 parts |
| name: S-LEK KW-10 (24%), manufactured by Sekisui | |
| Chemical Co., Ltd.) | |
| (3) Surfactant (trade name: EMULGEN 109P, manufactured | 5 parts |
| by Kao Corporation) | |

Formulation of Undercoat Layer Forming Liquid D

| | |
|---|---|
| (1) Ion-exchange water | 945 parts |
| (2) Water-soluble nylon (Water-soluble polyamide resin) | 50 parts |
| (trade name: AQ NYLON P-70, manufactured by Toray | |
| Industries Inc.) | |
| (3) Surfactant (trade name: EMULGEN 109P, manufactured | 5 parts |
| by Kao Corporation) | |

Formulation of Undercoat Layer Forming Liquid E

| | |
|---|---|
| (1) Ion-exchange water | 945 parts |
| (2) Water-soluble nylon (Water-soluble polyamide resin) | 50 parts |
| (trade name: AQ NYLON A-90, manufactured by Toray | |
| Industries Inc.) | |
| (3) Surfactant (trade name: EMULGEN 109P, manufactured | 5 parts |
| by Kao Corporation) | |

Formulation of Undercoat Layer Forming Liquid F

| | | |
|---|---|---|
| (1) Ion-exchange water | 733 | parts |
| (2) Water-soluble polyvinyl acetal solution (trade | 250 | parts |
| name: S-LEK KW-3 (20%), manufactured by Sekisui | | |
| Chemical Co., Ltd.) | | |
| (3) Surfactant (trade name: EMULGEN 109P, | 5 | parts |
| manufactured by Kao Corporation) | | |
| (4) Colloidal silica (trade name: SNOWTEX O, | 13 | parts |
| manufactured by Nissan Chemical Industries, Ltd.) | | |
| (3) Surfactant (trade name: EMULGEN 109P, | 5 | parts |
| manufactured by Kao Corporation) | | |

Formulation of Undercoat Layer Forming Liquid G

| | |
|---|---|
| (1) Deionized alkaline-treated gelatin (isoelectric | 50 parts |
| point: 5.0) | |
| (2) Ion-exchange water | 250 parts |
| (3) Methanol | 700 parts |

Formulation of Undercoat Layer Forming Liquid H

| | |
|---|---|
| (1) Ion-exchange water | 708 parts |
| (2) Water-soluble polyvinyl acetal solution (trade | 250 parts |
| name: S-LEK KW-3 (20%), manufactured by Sekisui | |
| Chemical Co., Ltd.) | |
| (3) Surfactant (trade name: EMULGEN 109P, manufactured | 5 parts |
| by Kao Corporation) | |
| (4) Colloidal silica (trade name: SNOWTEX O, manufactured | 38 parts |
| by Nissan Chemical Industries, Ltd.) | |

Preparation of Ink-Receiving Layer Forming Liquid

(1) Fumed silica particles, (2) ion-exchange water, and (3) a dispersant shown in the following formulation were mixed and dispersed by using an ultrasonic disperser (available from SMT Co., Ltd.). The obtained dispersion liquid was heated at 45° C. for 20 hours, and then (4) boric acid, (5) polyvinyl alcohol, (6) a surfactant, and (7) polyaluminum chloride were added thereto at 30° C., to provide an ink-receiving layer forming liquid A.

Formulation of Ink-Receiving Layer Forming Liquid A

| | | |
|---|---|---|
| (1) Fumed silica particles (first inorganic fine | 100 | parts |
| particles) (trade name: AEROSIL 300SV, available | | |
| from Nippon Aerosil Co., Ltd.) | | |
| (2) Ion-exchange water | 480 | parts |
| (3) 51.5% aqueous solution of dispersant (trade | 8.7 | parts |
| name: SHALLOL DC-902P, available from Dai-ichi | | |
| Kogyo Seiyaku Co., Ltd.) | | |
| (4) Boric acid (crosslinking agent) | 45.4 | parts |
| (5) Polyvinyl alcohol (10%-aqueous solution, trade name: | 290 | parts |
| JM33, available from Japan VAM & Poval Co., Ltd.) | | |
| (6) Surfactant (10%-solution of EMULGEN 109P | 5 | parts |
| (trade name, manufactured by Kao Corporation)) | | |
| (7) Polyaluminum chloride | 15 | parts |

The PB ratio ([solid content of first inorganic fine particles]/[solid content of second water-soluble resin]) of the ink-receiving layer forming liquid A was calculated by: [solid content of the (1) fumed silica particles]/[solid content of the (5) polyvinyl alcohol]=100/(290×0.07)=4.93.

Preparation of Crosslinking Agent Liquid 1

Components shown in the following formulation were dissolved and mixed under ambient temperature to provide a crosslinking agent liquid 1.

| | | |
|---|---|---|
| (1) Ion-exchange water | 89.4 | parts |
| (2) Ammonium carbonate (pH adjuster) | 4 | parts |
| (3) Boric acid (crosslinking agent) | 0.65 | parts |
| (4) Surfactant (10%-solution of EMULGEN 109P (trade | 6 | parts |
| name, manufactured by Kao Corporation)) | | |

Preparation of Inkjet Recording Medium (1)

The front surface of the water-resistant support was subjected to a corona discharge treatment, and the undercoat layer coating liquid A having the following formulation was applied at 10 g/m² to the front surface by a wire bar coater. After the application, the resultant was dried at 70° C. for 2 minutes to form an undercoat layer having a solid coating amount of 0.5 g/m².

Then, the ink-receiving layer forming liquid A was coated on the undercoat layer by using a slide bead coater in a coating amount of 130 g/m². The coated layer was dried at 80° C. (wind velocity: 3 msec) in a hot air dryer for 2 minutes. During the drying, the coated layer showed constant-rate of drying. Immediately after the 2 minutes-drying, the resultant was immersed in the crosslinking agent liquid 1 for 1 second. The resultant was then dried at 80° C. for 10 minutes. As the result, an inkjet recording medium (1) was obtained.

### Example 2

An inkjet recording medium (2) was prepared in substantially the similar manner as that for the inkjet recording medium (1), except that the undercoat layer forming liquid B was used in place of the undercoat layer forming liquid A.

### Example 3

An inkjet recording medium (3) was prepared in substantially the similar manner as that for the inkjet recording medium (1), except that the applied amount of the undercoat layer forming liquid A, which was 10 g/m², was changed to 30 g/m².

### Example 4

An inkjet recording medium (4) was prepared in substantially the similar manner as that for the inkjet recording medium (1), except that the undercoat layer forming liquid C was used in place of the undercoat layer forming liquid A.

### Example 5

An inkjet recording medium (5) was prepared in substantially the similar manner as that for the inkjet recording medium (1), except that the undercoat layer forming liquid D was used in place of the undercoat layer forming liquid A.

### Example 6

An inkjet recording medium (6) was prepared in substantially the similar manner as that for the inkjet recording medium (1), except that the undercoat layer forming liquid E was used in place of the undercoat layer forming liquid A.

### Example 7

An inkjet recording medium (7) was prepared in substantially the similar manner as that for the inkjet recording medium (1), except that the undercoat layer forming liquid F was used in place of the undercoat layer forming liquid A.

### Example 8

An inkjet recording medium (8) was prepared in substantially the similar manner as that for the inkjet recording medium (1), except that the applied amount of the undercoat layer forming liquid A, which was 10 g/m², was changed to 60 g/m².

### Example 9

An inkjet recording medium (9) was prepared in substantially the similar manner as that for the inkjet recording medium (1), except that the applied amount of the undercoat layer forming liquid A, which was 10 g/m², was changed to 20 g/m².

### Example 10

An inkjet recording medium (10) was prepared in substantially the similar manner as that for the inkjet recording medium (5), except that the applied amount of the undercoat layer forming liquid D, which was 10 g/m², was changed to 20 g/m².

### Comparative Example 1

An inkjet recording medium (11) was prepared in substantially the similar manner as that for the inkjet recording medium (1), except that the undercoat layer forming liquid G was used in place of the undercoat layer forming liquid A.

### Comparative Example 2

An inkjet recording medium (12) was prepared in substantially the similar manner as that for the inkjet recording medium (1), except that the undercoat layer forming liquid H was used in place of the undercoat layer forming liquid A.

### Comparative Example 3

An inkjet recording medium (13) was prepared in substantially the similar manner as that for the inkjet recording medium (1), except that the ink-receiving layer forming liquid A was coated on the support without coating the undercoat layer forming liquid A after subjecting the front surface of the support to the corona discharge treatment.

Evaluation of Color Density (Dmax)

A solid black image was printed on each of the inkjet recording media obtained in the Examples and Comparative examples by using an inkjet printer (trade name: A700, manufactured by Seiko Epson Corporation) under the condition of the temperature of 23° C. and the relative humidity of 50%, and the image density of the resultant black image portion was measured with a reflection densitometer (trade name: X-RITE 310TR, manufactured by X-rite Incorporated.).

Brittleness-Resistance

Each inkjet recording medium that was cut out in a size of 3 cm×10 cm was left in an environment of 23° C. and 15% over one night; the inkjet recording medium was wound around several kinds of cylindrical rods having different diameters from each other in a manner that the ink-receiving layer faced to the outside; and the ink-receiving layer was subjected to visual observation to see whether cracks were developed therein. In accordance with the smallest diameter of the cylindrical rods at which no cracks were developed, the inkjet recording medium was graded as follows.

### Evaluation Criteria:

A: No crack was observed at a cylindrical rod diameter of 10 mm or less.
B: No crack was observed at a cylindrical rod diameter of 20 mm or less.
C: No crack was observed at a cylindrical rod diameter of 30 mm or less.
D: No crack was observed at a cylindrical rod diameter of 40 mm or less.
E: A crack was observed at a cylindrical rod diameter of over 40 mm.

Water-Resistance

Each inkjet recording medium that was cut out in a size of 3 cm×10 cm was immersed in ion-exchanged water for 1 hour in an environment of 23° C.; and then it was taken out of the water and air-dried. The ink-receiving layer of the inkjet recording medium after dried was subjected to visual observation to see the extent of cracks and changes in glossiness degree. Then, in accordance with the observation, the inkjet recording medium was graded as follows.

### Evaluation Criteria

A: No crack and no change in glossiness degree were observed at all.
B: Practically acceptable. The glossiness degree changed slightly, but no crack was observed.
C: A slight crack was observed.
D: Practically intolerable. Many cracks were observed, and they were not acceptable on practical use.

Table 1 shows the evaluation results along with the configurations of the undercoat layers of the inkjet recording media (1) to (13). In Table 1, “Kind of IJ paper” indicates the kind of the inkjet recording media. In “Kind” of the polymer (B) column in the undercoat layer column, the kind of the first water-soluble resin is shown for the inkjet recording media according to Examples, and the kind of polymers contained in the undercoat layer is shown for the inkjet recording media according to Comparative Examples. The unit of “Amount” in the polymer (B) column is g/cm².

TABLE 1

| | | Undercoat layer | | | | Evaluation | | |
|---|---|---|---|---|---|---|---|---|
| | Kind of | Polymer (B) | | First inorganic | | | Brittleness- | Water- |
| | IJ paper | Kind | Amount | fine particles (P) | PB ratio | Dmax | resistance | resistance |
| Example 1 | 1 | Polyvinyl acetal KW-3 | 0.50 | — | 0.00 | 2.40 | A | A |
| Example 2 | 2 | Polyvinyl acetal KW-3 | 0.05 | — | 0.00 | 2.32 | B | A |
| Example 3 | 3 | Polyvinyl acetal KW-3 | 1.50 | — | 0.00 | 2.38 | A | B |
| Example 4 | 4 | Polyvinyl acetal KW-10 | 0.50 | — | 0.00 | 2.41 | A | A |
| Example 5 | 5 | Water-soluble nylon P-70 | 0.50 | — | 0.00 | 2.38 | A | A |
| Example 6 | 6 | Water-soluble nylon A-90 | 0.50 | — | 0.00 | 2.32 | B | A |
| Example 7 | 7 | Polyvinyl acetal KW-3 | 0.50 | Silica | 0.05 | 2.37 | B | A |
| Example 8 | 8 | Polyvinyl acetal KW-3 | 3.00 | — | 0.00 | 2.39 | A | C |
| Example 9 | 9 | Polyvinyl acetal KW-3 | 1.00 | — | 0.00 | 2.34 | A | A |
| Example 10 | 10 | Water-soluble nylon P-70 | 1.00 | — | 0.00 | 2.40 | A | A |
| Comparative Example 1 | 11 | Gelatin | 0.50 | — | 0.00 | 2.22 | D | A |
| Comparative Example 2 | 12 | Polyvinyl acetal KW-3 | 0.50 | Silica | 0.15 | 2.25 | E | A |
| Comparative Example 3 | 13 | — | — | — | — | 2.23 | E | A |

All publications, patent applications, and technical standards mentioned in this specification are herein incorporated by reference to the same extent as if such individual publication, patent application, or technical standard was specifically and individually indicated to be incorporated by reference. It will be obvious to those having skill in the art that many changes may be made in the above-described details of the preferred embodiments of the present invention. It is intended that the scope of the invention be defined by the following claims and their equivalents.

What is claimed is:

1. An inkjet recording medium comprising a non-water-absorptive support, an undercoat layer provided on the non-water-absorptive support, and an ink-receiving layer provided on the undercoat layer,
the undercoat layer comprising a first water-soluble resin selected from the group consisting of: a water-soluble polyamide resin that is other than an α-amino acid derived polyamide resin; a derivative of a water-soluble polyamide resin that is other than a derivative of an α-amino acid derived polyamide resin; and a water-soluble polyvinyl acetal,
the ink-receiving layer comprising first inorganic fine particles and a second water-soluble resin, and
in the case that the undercoat layer comprises second inorganic fine particles, a mass ratio of a content of the second inorganic fine particles in the undercoat layer to a content of the first water-soluble resin in the undercoat layer being 0.1 or less.

2. The inkjet recording medium of claim 1, wherein a mass ratio of the content of the first inorganic fine particles to the content of the second water-soluble resin in the ink-receiving layer is 3 or more.

3. The inkjet recording medium of claim 1, wherein the content of the first water-soluble resin in the undercoat layer is in the range of from 0.02 g/m² to 5 g/m² in terms of a solid content by mass.

4. The inkjet recording medium of claim 1, wherein a mass ratio of the content of the second inorganic fine particles to the content of the first water-soluble resin in the undercoat layer is less than 0.05.

5. The inkjet recording medium of claim 1, wherein the water-soluble polyamide resin that is other than an α-amino acid derived polyamide resin is a copolymer that is formed by copolymerizing polyamide resin and a hydrophilic compound, and the derivative of a water-soluble polyamide resin that is other than a derivative of an α-amino acid derived polyamide resin is a derivative of a copolymer that is formed by copolymerizing polyamide resin and a hydrophilic compound.

6. The inkjet recording medium of claim 5, wherein the polyamide resin is a reaction product from ε-caprolactam and dicarboxylic acid.

7. The inkjet recording medium of claim 5, wherein the hydrophilic compound comprises at least one of a hydrophilic nitrogen-containing cyclic compound or a polyalkylene glycol.

8. The inkjet recording medium of claim 1, wherein the second water-soluble resin is polyvinyl alcohol.

9. The inkjet recording medium of claim 1, wherein the first inorganic fine particles are silica fine particles.

10. The inkjet recording medium of claim 1, wherein the ink-receiving layer comprises a crosslinking agent.

11. The inkjet recording medium of claim 1, wherein the content of the first water-soluble resin in the undercoat layer is in the range of from 0.05 g/m² to 1 g/m² in terms of a solid content by mass.
